(19) United States
(12) Patent Application Publication
(10) Pub. No.: US 2013/0203004 A1
(43) Pub. Date: Aug. 8, 2013

(54) METHOD FOR INCREASING THE TEMPERATURE HOMOGENEITY IN A PIT FURNACE

(71) Applicant: Rudiger Eichler, Taby (SE)

(72) Inventor: Rudiger Eichler, Taby (SE)

(21) Appl. No.: 13/642,909

(22) PCT Filed: May 3, 2011
(86) PCT No.: PCT/EP2011/002206

§ 371 Date: Nov. 8, 2012

(30) Foreign Application Priority Data
May 4, 2010 (SE) 1050443.9

(51) Int. Cl. C21D 9/70; F27B 3/22; F27B 3/20

(52) U.S. Cl. CPC C21D 9/70; F27B 3/205; F27B 3/225
USPC 432/19

(57) ABSTRACT

A method for increasing temperature homogeneity in a pit furnace wherein at least one ingot to be heated leans against an inner wall of the pit furnace for providing a space having a triangular cross-section under the ingot between the ingot and the inner wall includes arranging at least one lance for an oxidant with an oxygen content of at least 85 percent by weight so that its orifice is arranged inside the furnace for supplying the oxidant to the space.

### BACKGROUND OF THE INVENTION

The present invention relates to a method for increasing the temperature homogeneity in a pit furnace.

During heating of ingots in pit furnaces, the ingots are normally positioned leaning against opposite inner walls in the pit furnace, and resting on the furnace floor, often on a layer of oxide scale from previous runs.

In such furnaces, it is desirable to achieve good temperature homogeneity, in other words to minimize temperature gradients inside the furnace. However, there are problems with the normally used furnace geometry in which the ingots are positioned leaning against the inner walls of the furnace.

In the conventional art, air burners are used to heat such pit furnaces. Such air burners turn over quite large volumes of air and fuel, leading to large volumes of hot combustion gases being circulated in the furnace. By, for example, arranging an air burner in one of the short sides of the furnace, and an exhaust port on the same short side, but below or above the burner, lengthwise circulation along the whole furnace can be accomplished, whereby the gas volumes from the air burner can yield sufficient temperature homogeneity in the furnace.

However, in order to decrease the amount of formed CO and Oₓ, and in order to increase energy efficiency, more and more often oxyfuel combustion, i.e. where an oxidant with high oxygen content is used to combust a fuel, is used. Since such oxidants comprise considerably less ballast in the form of nitrogen than what is the case when air is used as the oxidant, smaller volumes of combustion gases arise, in many cases not more than ⅕ as compared to a corresponding air burner, and therefore it is more difficult to achieve a sufficient temperature homogeneity.

It is especially common that the upper parts of the ingots risk overheating at the same time as the lower parts become too cool.

There are limited possibilities to direct the combustion reaction to cooler parts of the furnace, because of the risk of local overheating close to the combustion location. In general, it is also not possible to compensate for the smaller amounts of combustion gases by increasing the power of the oxyfuel burners. To arrange a large number of oxyfuel burners in one and the same furnace is possible, but very costly. Moreover, the result will still not be adequate, since it is desirable to heat different numbers of ingots in the same furnace at different occasions.

### SUMMARY OF THE INVENTION

The present invention solves the above problems.

Hence, the present invention relates to a method for increasing the temperature homogeneity in a pit furnace in which at least one ingot to be heated is caused to lean against an inner wall of the pit furnace so that a space having triangular cross-section is present under the ingot, between the ingot and said inner wall, and is characterised in that at least one lance for an oxidant with an oxygen content of at least 85 percent by weight is caused to be arranged in a furnace wall so that its orifice is arranged inside the furnace and so that oxidant can be supplied to said space.

### BRIEF DESCRIPTION OF THE DRAWINGS

In the following, the invention will be described in detail, with reference to exemplifying embodiments of the invention and to the appended drawing figures, of which:

FIG. 1 is a partly cut away perspective view showing a conventional pit furnace;

FIG. 2 shows the pit furnace of FIG. 1 from a long side;

FIG. 3 shows the pit furnace of FIG. 1 from the top;

FIG. 4 is a partly cut-away perspective view showing a pit furnace according to a first preferred embodiment of the present invention;

FIG. 5 shows the pit furnace of FIG. 4 from a long side;

FIG. 6 shows the pit furnace of FIG. 4 from a short side;

FIG. 7 shows the pit furnace of FIG. 4 from the top;

FIG. 8 is a view corresponding to that in FIG. 5, but which shows a pit furnace according to a second preferred embodiment of the present invention as seen from a long side;

FIG. 9 shows the pit furnace of FIG. 8 from a short side; and

FIG. 10 shows the pit furnace of FIG. 8 from the top.

### DESCRIPTION OF THE INVENTION

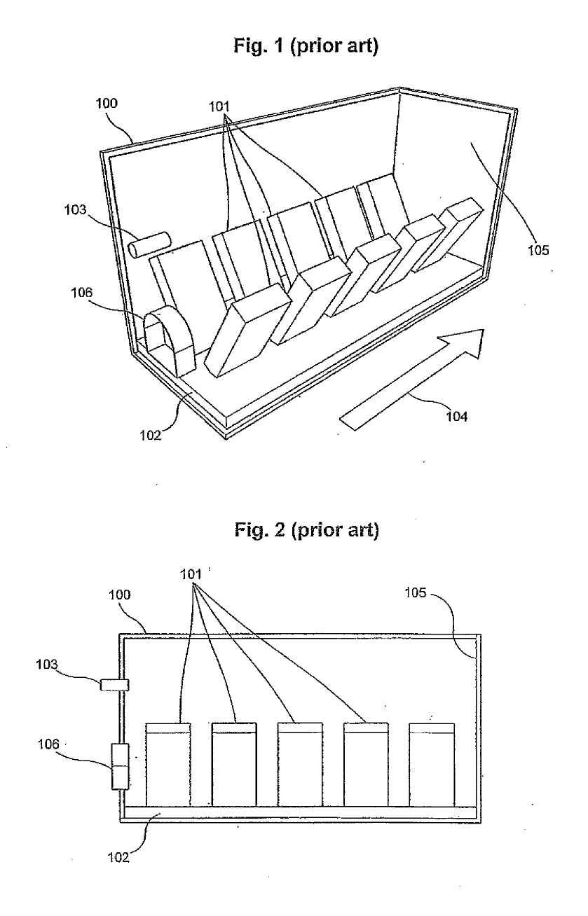

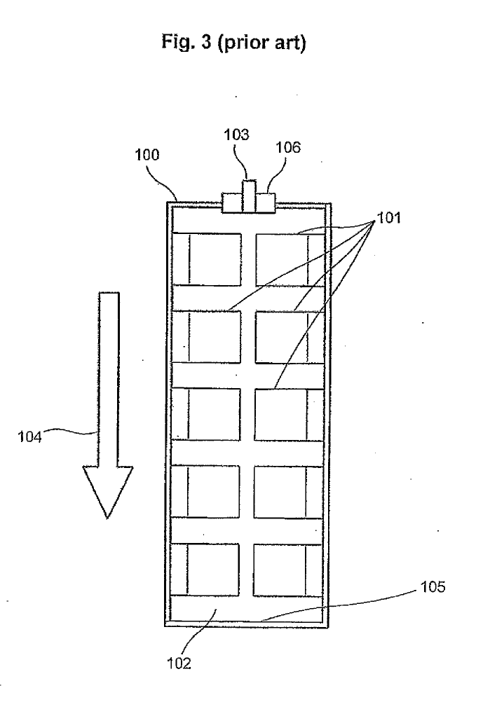

FIGS. 1-3 illustrate, using a common set of reference numerals, a conventional pit furnace 100 in which ten ingots 101 are heated in two rows of five ingots each. The ingots rest upon a bed 102 of oxide scale from previous runs, and are standing leaning, over two rows, against the opposite inner walls of the respective long sides of the furnace 100, along the longitudinal direction 104 of the furnace 100.

The furnace 100 is heated using a conventional air burner 103, directed along the longitudinal direction 104 of the furnace 100. The air burner 103 is arranged in the wall in one of the short ends of the furnace 100. Since the furnace is shown partly cut away in FIGS. 1-3, said short end is not shown, together with the ceiling of the furnace 100 and one of its long sides. The hot combustion gases from the air burner 103 flow in the direction 104 along the rows of ingots 101, and turns over at a distal short end 105 of the furnace to then again flow back to the short end in which the air burner 103 is arranged, and there be evacuated through an exhaust channel 106 for flue gases. Since the air burner 103 and the exhaust channel 106 are arranged in the same wall in the furnace 100 but at different heights, natural convection arises resulting in sufficient temperature homogeneity throughout the whole furnace chamber.

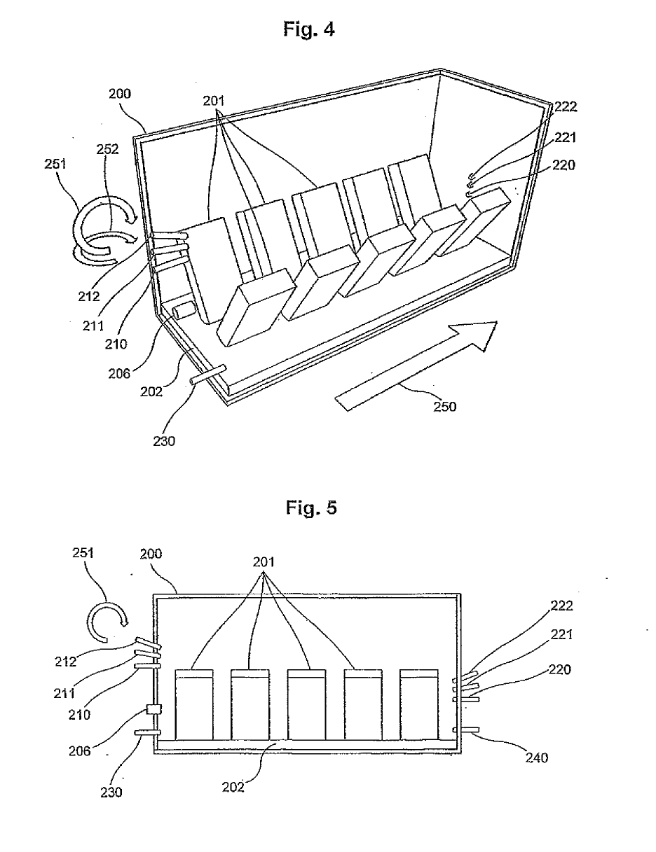

FIGS. 4-7 show, with common reference numerals, a pit furnace 200 in which a method according to the present invention for increasing the temperature homogeneity is applied. The furnace 200 is largely similar to the furnace 100 shown in FIGS. 1-3. In the furnace 200 there is arranged a number of, at least two, ingots 201. The ingots 201 are arranged along two rows along the main longitudinal direction 250 of the furnace 200, each leaning against a respective first and second opposite inner walls of the pit furnace 200, so that the ingots 201 form a space 203 having a V-shaped cross-section (see FIG. 6) between and above them along said first and second inner walls. Said inner walls preferably constitute the inner walls of the long sides of the furnace 200. In FIGS. 4-7, which are partly cut away, one of said walls is not shown.

The ingots 201 rest upon a bed 202 of oxide scale similar to the bed 102. Alternatively, the ingots 201 may rest directly upon the furnace floor.

An exhaust channel 206 for flue gases is arranged in one of the short sides of the furnace 200.

It is preferred that at least one separate lance 211, 212 for oxidant, and at least one separate lance 210 for fuel, are arranged in a furnace wall so that their orifices are arranged inside, opening out into, the furnace 200 at a distance from each other, and so that oxidant and fuel, respectively, can be supplied to the V-shaped space 203 between the ingots 201 and to react therein.

The lower fuel lance 210 and the two oxidant lances 211, 212 arranged above the orifice of the fuel lance 210 together form a lance aggregate or group. The aggregate may also be designed with other configurations of lances for fuel and oxidant, as long as the orifice of at least one oxidant lance is arranged above at least one fuel lance.

It is preferred that the distance between each oxidant and fuel lance is at least 5 cm.

The oxidant being supplied via at least one, but preferably all, lances for oxidant has, according to the invention, an oxygen content of at least 85 percent by weight, preferably at least 95 percent by weight. The fuel may be any suitable, conventional, gaseous, liquid or solid fuel, such as oil or natural gas. It is preferred that the fuel is a gaseous or liquid fuel.

It is preferred that at least one of the lances 211, 212 for oxidant, preferably all lances 211, 212 for oxidant, is arranged with their orifice arranged above the orifice of at least one fuel lance 210, and is directed so that the oxidant flows obliquely downwards and along the longitudinal direction of the V-shaped space 203, essentially parallel to said first and second furnace walls. In other words, the oxidant is supplied to the V-shaped space 203 between the ingots 201, so that the downwards inclined stream of oxidant runs in the longitudinal direction 250 of the furnace 200. Moreover, it is preferred that the stream of oxidant from each of the oxidant lances 211, 212 is arranged to cut through an area in the space 203 in which the fuel is supplied using the fuel lance 210. Preferably, at least one stream of oxidant and at least one stream of fuel meet in the space 203.

Since the oxidant has such high oxygen content, the amount of hot combustion gases originating from the fuel and the oxidant being supplied through lances 210, 211, 212 will be substantially smaller than the corresponding amount of combustion gases originating from the air burner 103 for the corresponding heating powers. As described above, operation with such oxidant conventionally gives rise to deteriorated temperature homogeneity. Notably, it has proven difficult to achieve sufficiently high temperatures towards the bottom of the V-shaped space 203 between the ingots 201, i.e. in the vicinity of the oxide scale bed 202 at the bottom of the furnace 200, as well as in the space 205 (see FIG. 6) having a triangular cross-section being present under the ingots 201, between each ingot 201 or row of ingots and the furnace wall against which the ingot or ingots 201 is leaning.

Thus, the oxidant flows out from lances 211, 212, and meets the fuel flowing out from the fuel lance 210 in the V-shaped space 203 between the ingots 201. Since the oxidant is supplied this way, through a separate lance, the geometrical shape and the velocity of the oxidant stream may be controlled so that it may carry with it the resulting mixture of fuel and oxidant down towards the bottom of the V-shaped space 203. Thereby, the temperature there can be increased without any increased risk of overheating, which had been the case if for example an air burner had been positioned closer to the bottom or if a separate oxidant lance had been positioned so that it opened out directly in close vicinity to the ingots 201.

The fuel lance 210 may be arranged horizontally and so that the fuel stream is directed essentially straight along the main longitudinal direction of the V-shaped space. However, it is preferred that the fuel lance is somewhat inclined downwards as compared to the horizontal plane, at an angle of maximally 5°. The respective oxidant streams from lances 211, 212 are in this case directed with the same or a larger angle of inclination as compared to the horizontal plane. Hereby, the downwards inclined oxidant stream can carry the combustion mixture with it downwards towards the bottom of the V-shaped space.

According to a preferred embodiment, at least one oxidant lance 211, 212 opens out above all supply locations for fuel, in the present example thus the fuel lance 210, which are arranged in the same furnace wall in which the orifice of the oxidant lance 211, 212 in question is arranged. This results in all fuel being supplied via the lance 210, 211, 212 aggregate in question is conveyed downwards in the V-shaped space 203 using the oxidant stream from the lance in question.

According to an especially preferred embodiment, the oxidant is supplied through at least one oxidant lance 211, 212, preferably the oxidant lance 212 the orifice of which is arranged at the top position in each respective aggregate, at high velocity. This results in increased convection in the furnace chamber, which compensates for the smaller amounts of combustion gases as compared to if one or several air burners had been used instead of the oxyfuel burner which is embodied by the lance aggregate 210, 211, 212.

It is preferred that the lancing velocity is at least 100 m/s, which in many applications results in sufficient convection in the furnace chamber. Furnace atmosphere gases are sucked into the combustion mixture, which lowers the combustion temperature and thereby leads to less formed NOₓ. Then, in combination with the above described downwards inclined oxidant stream, the whole furnace chamber, including the bottom of the V-shaped space 203, will be sufficiently warm without any risk for local overheating.

According to an especially preferred embodiment, oxidant is lanced through at least one oxidant lance 211, 212 at a velocity which is at least the sonic velocity. This results in heavily increased convection and recirculation throughout the whole furnace chamber, with corresponding improved temperature homogeneity and decreased CO and NOₓ rates. Such a method is especially preferred in larger furnaces.

Most preferred is to supply oxidant through at least one oxidant lance 211, 212 at a velocity of at least Mach 1.5. Such high lancing velocity has been found to result in convection which increases as a function of the velocity in a non-linear manner. Above about Mach 1.5, combustion of flameless type can be achieved, in which the combustion can take place in the majority of the furnace chamber simultaneously, with no clearly distinguishable flame. Therefore, this results in very good temperature homogeneity even in difficult to access parts of the furnace chamber.

It is preferred that at least one oxidant lance 211, 212, more preferably each oxidant lance, is mounted so that the respective oxidant streams out into the furnace chamber at an angle of more than 0° and but more than 20°, most prefer between 3 and 5°, as compared to the horizontal plane. Thus, at least one oxidant lance 211, 212 is inclined from a horizontal position in the direction denoted by the arrow 251. This results, in a pit furnace 200 of normal size, in that the mixture of oxidant and fuel is conveyed sufficiently far towards the bottom of the V-shaped space 203 so that a desired temperature homogeneity can be achieved.

According to an especially preferred embodiment, more than one oxidant lance 211, 212, arranged with their respective orifices one above the other, is used as is illustrated in FIGS. 4-7. In this case, it is preferred that the downwards inclined angle, in comparison to the horizontal plane, with which the resulting oxidant stream is directed, is equal to or larger for oxidant lances 212 having respective orifices arranged further up than for oxidant lances 211 having respective orifices arranged further down. In the present exemplifying case with two oxidant lances 211, 212, it is preferred that a lower oxidant lance 211 has an angle of more than 0° and not more than 10°, while an upper oxidant lance 212 has an angle of more than 0° and not more than 20°, however at least the same angle as the upper oxidant lance 212. By arranging several oxidant lances this way, one above the other, the total flow of fuel and oxidant can be controlled such that a good spread of fuel and oxidant can be achieved in the space 203.

In the exemplifying embodiment illustrated in FIGS. 4-7, a first group or aggregate of lances, comprising a fuel lance 210 and two oxidant lances 211, 212, arranged in one of the short sides of the furnace 200, and a second lance aggregate, comprising a fuel lance 220 and two oxidant lances 221, 222, is arranged in the other, opposite short side of the furnace 200. Both lance aggregates hence comprise a respective fuel lance 210, 220 above the orifice of which the orifices of two respective oxidant lances 211, 212, 221, 222 are arranged. Each such aggregate may be designed having other configurations of lances for fuel and oxidant, as long as at least one downwards inclined oxidant lance for oxidant with more than 85 percent by weight oxygen has its orifice arranged above the level for at least one fuel lance in each aggregate.

As is clear from FIGS. 5 and 6, the two lance aggregates are arranged at different heights in the furnace 200. By such an arrangement, the temperature homogeneity can be further increased because of circulation effects arising in the furnace chamber. It is in this case preferred that the fuel lance 210 having its orifice arranged at the lowest height in the first aggregate of lances 210, 211, 212 is arranged with its orifice at a height above the furnace floor which is between 0.7 and 1.2 meters above the level above the furnace floor at which the orifice of the lance 220, the orifice of which is arranged at the lowest height in a second aggregate of lances 220, 221, 222, is arranged. It is furthermore preferred that all such aggregates of fuel and oxidant lances 210, 211, 212, 220, 221, 222 the orifices of which are arranged so that the respective lance opens out into the V-shaped space 203 are arranged so that no lance orifice is arranged at a vertical level from the furnace floor so high so that overheating of the ingots 201 is risked as a direct consequence of the thermal energy being supplied locally as a result of the fuel or oxidant which is supplied through such a lance. What this vertical level is will depend upon the design of the furnace 200 as well as upon the positioning and shape of the ingots 201, but it is preferred that no such lance has its orifice arranged at a level below 1.5 meters above the floor.

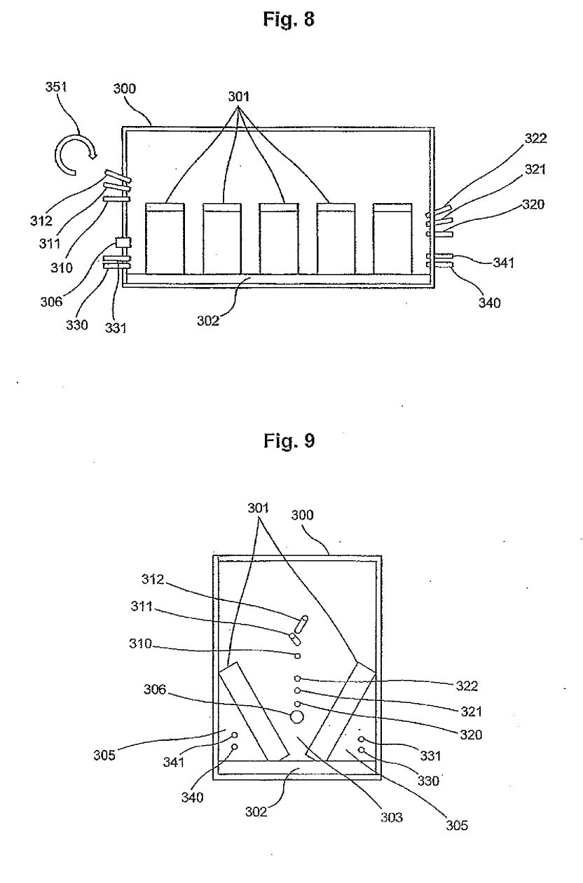

FIGS. 8-10, the views of which correspond to the views of FIGS. 5-7, illustrate an alternative embodiment, wherein a pit furnace 300, in a way which is similar to the above described in connection to FIGS. 4-7, comprises ingots 301 supported by an oxide scale bed 302 and heated by two opposite aggregates of lances 310, 320 for fuel in combination with lances 311, 312, 321, 322 for oxidant. The arrow 350 denotes the longitudinal direction of the furnace 300. An exhaust channel 306 is for flue gases.

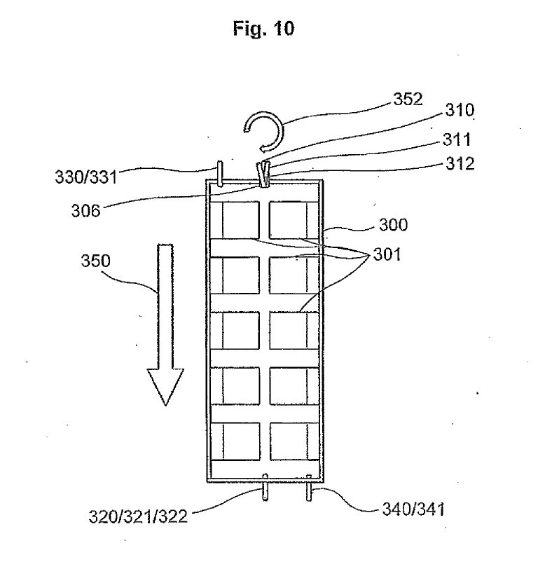

As most clearly can be seen in FIGS. 9 and 10, the lances 311, 312 for oxidant are not, however, only inclined in relation to the horizontal plane in the direction of rotation pointed out by the arrow 351, similarly to the lances 211, 212 in FIGS. 4-7, but lances 311, 312 are also inclined in the horizontal plane, in relation to a longitudinally arranged vertical plane and in a direction of rotation pointed out by the arrow 352. As a consequence, the resulting mixture of oxidant and fuel in the V-shaped space 303 (see FIG. 9) between ingots 301 can be spread more evenly than what is possible when only arranging the lances 311, 312 at an angle in relation to the horizontal plane according to the above.

It is preferred to adjust the lance angles for each individual lance for oxidant depending on the actual application, so that the resulting temperature distribution in the V-shaped space 303 becomes as homogenous as possible. It is especially preferred that at least two lances 311, 312 for oxidant are mounted with their orifices arranged in the furnace chamber one above the other and so that their respective oxidant can stream out into the furnace chamber at different angles either in the horizontal plane and/or in the vertical plane. This results in even spread of the fuel/oxidant mixture but while still retaining the possibility to keep a low risk for local overheating because of the supplied oxidant. It is preferred that the angle in the horizontal plane, in the direction of rotation 352, between the oxidant stream from each individual oxidant lance and the main longitudinal direction of the V-shaped space 303, is 10° or less in any direction.

It is especially preferred that at least one lance for oxidant 311, 312, 321, 322, preferably all such lances, are redirectable, so that it is possible to redirect their respective stream of oxidant in the horizontal plane and/or in the vertical plane. This will render the furnace 300 adjustable depending on changing operation prerequisites with for example different numbers of and/or differently sized ingots 301 to be heated.

According to a preferred embodiment, more than one lance for oxidant is used in the furnace, preferably in combination with one and the same lance for fuel, whereby the heating power in the furnace is controlled during operation by one or several lances being switched on or off, while the amount of supplied fuel is controlled so that it at each moment in time or at least over time stoichiometrically corresponds to the total oxygen supplied via the oxidant. In order to decrease the total heating power in the furnace from a certain higher power level to a certain lower power level, an oxidant lance may be operated in a pulsating manner, where the switched on and switched off time periods are controlled so that the mean emitted power becomes the desired power. Moreover or alternatively, one or several oxidant lances may be completely switched off.

In this context, it is preferred to commence the heating method with all oxidant lances switched on, whereby the total heating power is maximal. Once the furnace has reached a certain predetermined operating temperature, one or several oxidant lances may either be operated in a pulsating manner or alternatively be switched off. This decrease of the total heating power may be carried out in one or several steps, by altering the number of switched on oxidant lances and/or by altering the time periods for one or several oxidant lances being operated in a pulsating manner.

Thereafter, the total heating power can be successively decreased in the same manner, at the same time as the operating temperature is maintained in the furnace and until the ingots have reached a desired final temperature. Then, the total heating power can be further decreased, still in the same manner as described above, so that temperature equilibrium prevails during a holding time with constant ingot temperature.

During this whole procedure, it is preferred that at least one oxidant lance is operated with full power at each time. Moreover, it is preferred that at least one oxidant lance, being the oxidant lance having its orifice arranged furthest up in the furnace of the lances in an aggregate comprising at least a fuel lance and at least one oxidant lance, is operated at full power. It is especially preferred that this at least one oxidant lance is operated with the above described high lancing velocities. This way, it is possible to control the total heating power over a broad power interval and at all times ensure satisfactory convection and therewith temperature homogeneity in the whole furnace chamber, including the V-shaped space between the ingots.

If a total heating power is desired which is lower than that achieved when only one oxidant lance is operated at full power, it is preferred that only one oxidant lance is operated in a pulsating manner. This single oxidant lance is in this case preferably an oxidant lance which is the oxidant lance with its orifice arranged at the lowest height in an aggregate comprising at least one fuel lance and at least one oxidant lance, where the single lance has its orifice arranged above at least one fuel lance through which fuel is supplied.

In order to further increase the thermal homogeneity during the carrying out of a method according to the present invention, it is furthermore preferred that oxidant is supplied through different lances for oxidant, or through different constellations of lances for oxidant, in an alternating manner. Thus, one and the same total heating power can be maintained but using alternating oxidant lances. This leads to temperature homogenization over time, and decreases the risk of local overheating in so called “hot spots”.

It is especially preferred to convert an existing pit furnace operated with conventional air burners to instead being operated using oxyfuel combustion, by installing one or several fuel lances and one or several oxidant lances operated according to the above. By such conversion followed by such operation, an existing pit furnace can cost-efficiently be converted into more environmentally friendly oxyfuel operation without running into problems with poor thermal homogeneity in the furnace as a consequence.

Again with reference to the pit furnace 200 illustrated in FIGS. 4-7, it is furthermore preferred to increase the thermal homogeneity in the furnace 200 by arranging at least one lance 230 for an oxidant with an oxygen content of at least 85 percent by weight in an furnace wall so that the orifice of the lance is arranged inside the furnace 200 and so that oxidant can be supplied directly to the space 205 having a triangular cross-section (see FIG. 6) which is present under at least one ingot 201 which in turn is leaning against an inner wall of the pit furnace 200, between the ingot 201 and the wall. That the oxidant can be supplied directly to the space 205 is to be interpreted so that the stream of oxidant originating from the lance 230 streams into the space 205 without striking against any obstacles on its way. Preferably, the lance 230 opens out in the space 205 itself, but it may also open out some ways outside and shoot the oxidant stream into the space 205.

In case several ingots 201 are arranged in the furnace 200 along the same furnace wall, this space 205 of triangular cross-section will in general constitute an elongated, substantially cylinder-shaped body having triangular cross-section and being partly separated from the heated part of the furnace 200. In the case where oxyfuel is used to heat the furnace 200, it is difficult to achieve sufficiently elevated temperatures also in the space 205. This leads to problems both in case one or several ingots 201 lean along a row against the same inner wall and in case ingots lean against both opposite long sides, as is shown in FIGS. 4-7.

The height of the bed 202 of oxide scale varies during operation, and also across time during several operating cycles. Since oxidant lances 230, 240 the orifices of which are arranged opening out directly into the space 205 risk ending up below the level for the bed 202 when sufficient volumes of oxide scale are on the furnace floor, it is preferred to arrange all lances opening out into the space 205 under the ingots 201 at such height so that it is possible to surveil the oxide scale level and empty the furnace floor from oxide scale before it reaches the level for the orifices of installed lances.

It is especially preferred that the oxidant lances 230, 240 are arranged with their orifices arranged at a height above the furnace floor which is above the maximum level for an oxide scale bed appearing in the furnace during operation. More specifically, it is preferred that they are arranged to be at a height above the furnace floor of 0.5-1.0 meters.

Furthermore, it is preferred that the oxidant supplied from the lance 230, similarly to that supplied from lances 211, 212, is supplied at elevated velocities, preferably at least 100 m/s, more preferably at least sonic velocity, most preferably at least Mach 1.5. At such elevated lancing velocities, the above described advantages in terms of temperature homogeneity and low flame temperatures are achieved, in turn resulting in low CO and NOₓ rates. This is of special importance to avoid local overheating in the comparatively narrow space 205 under the ingots 201, and additionally leads to that the lance 230 can be positioned with its orifice arranged further up along the inner wall of the furnace 200 without the risk of it as a consequence giving rise to local overheating of ingots 201 at low oxide scale bed 202 depths. Moreover, the lanced high velocity oxidant stream will suck hot furnace gases into the space 205 from surrounding parts of the furnace 200, which additionally increases the thermal homogeneity in the furnace 200 by distributing thermal energy to the space 205.

The present inventors have surprisingly discovered that the formation of oxide scale during operation tends to consume large amounts of oxygen. It has been noted that this in some cases can lead to a lack of oxygen in the combustion reaction, whereby the concentration of CO in the furnace atmosphere very rapidly can be sharply increased. According to a preferred embodiment, use is made of this phenomenon in that the main combustion, in the main furnace chamber including those parts of the furnace 200 constituted by the space 205, is continuously controlled so that they are substoichiometric, by adjusting down the total amount of oxidant supplied through the oxidant lances 211, 212 the orifices of which are arranged above the space 205. Hence, this will lead to elevated levels of CO in the furnace atmosphere. This CO is then oxidized in the space 205 by aid of additionally supplied oxidant with at least 85 percent by weight oxygen, supplied through the oxidant lance 230 to the space 205. As a result of this additional oxidant, global stoichiometric equilibrium is achieved in the furnace 200.

In this case, no additional fuel is thus supplied to the space 205. Instead, the oxidant supplied through the lance 230 is caused to react mainly with the CO formed during incomplete combustion of fuel in the furnace 200, using oxidant supplied to a part of the furnace which is not constituted by the space under the ingot. Thereby, the combustion of the fuel takes place in two stages in the furnace 200, namely in a first stage during which CO is formed and a subsequent stage during which complete combustion to CO₂ takes place.

An alternative embodiment is shown in FIGS. 8-10, wherein a separate lance 331 for fuel supplies additional fuel, besides the fuel being supplied through lances 310, 320 to the V-shaped space 203 and to the rest of the furnace chamber, to the space 305 (see FIG. 9), with which fuel the oxidant supplied through the lance 330 is caused to react. In this case, no adjustment down of the amount of oxidant supplied to the rest of the furnace chamber is required to obtain substoichiometric combustion.

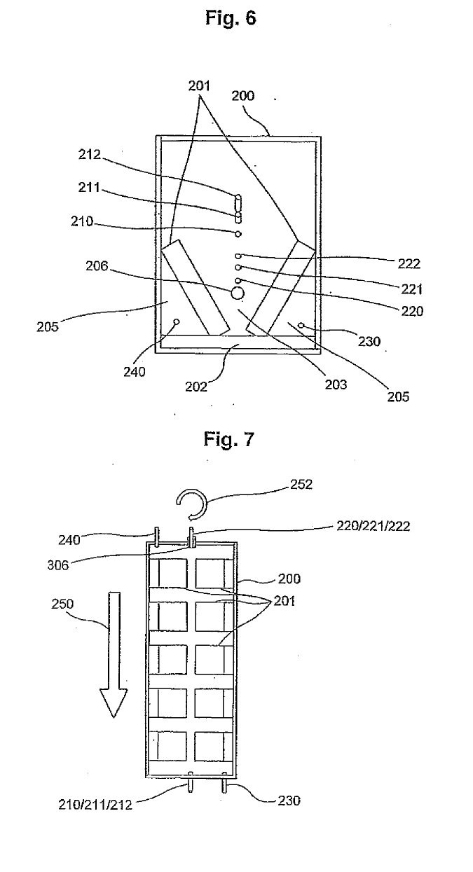

According to a preferred embodiment, more than one lance for oxidant is arranged in the space 205, 305. Thus, in FIGS. 4-7 a corresponding lance 240 is also arranged in the opposite short end of the furnace 200, in addition to the lance 230, so that it opens out into the space 205 under the ingots 201 which are leaning against the opposite long side of the furnace. In this case, when at least two ingots 201 that are to be heated are leaned against one each of respective first and second opposite inner walls of the pit furnace 200, so that a respective space 205 with triangular cross-section is formed under each respective ingot, it is in general preferred that at least one respective lance 230, 240 for oxidant having an oxygen content of at least 85 percent by weight is arranged in one respective furnace wall, arranged with its orifice so that it opens out into the furnace 200 and so that oxidant can be supplied to the respective space 205, and so that the lances 230, 240 in addition are arranged with their orifices arranged to open out in one opposite furnace wall each, and directed so that the streams of oxidant together give rise to a circulating flow motion in the furnace 200. Hence, in FIG. 7, the circulating flow motion will, starting out from lance 240, run in the direction 250 to the opposite short end, perpendicularly away from the orifice of the lance 230, thereafter back to the first short side and finally perpendicularly back to the orifice of the lance 240. Such an arrangement will result in good temperature homogeneity throughout the whole space 205 under all ingots arranged in the furnace 200.

In FIGS. 8-10 a corresponding arrangement is illustrated, comprising oxidant lances 330 and 340, respectively. In this case, the preferred but not required design with one respective fuel lance 331, 341 used in combination with each oxidant lance 330, 340 is also shown.

What has been said above regarding alternating operation with several different oxidant lances for increasing temperature homogeneity is also valid for operation of lances 230, 240, 330, 340. Hence, it is possible to operate for example lances 230, 240 in an alternating manner, so that firstly one 230, then the other 240, thereafter again the first 230 lance is operated, while the lance which at each point in time is not operated is instead switched off. It is also possible and preferred to perform such alternating operation comprising both oxidant lances 230, 240, 330, 340 opening out into the space 205, 305 as well as oxidant lances 211, 212, 221, 222, 311, 312, 321, 322 opening out into the space 203, 303. With such a mode of operation, the temperature homogeneity can be maximized over time, and local overheating can be avoided, in a way which easily can be adapted to current operating conditions.

According to a preferred embodiment, the temperature inside the furnace is measured using temperature sensors (not shown), which are conventional as such, at different locations where local overheating can be feared, and the alternating operation is controlled so that the heating power is decreased in places where the measured temperature is so high that overheating is risked, i.e. higher than a certain predetermined value which is dependent upon the heated material.

Because of the above said concerning the oxygen consumption of the oxide scale formation process, it is, in order to control the CO concentration in the furnace, also preferred to measure the oxygen level in the furnace during operation, for example using one or several conventional lambda sensors and, based upon this measurement value or these measurement values, control the supplied amount of oxygen through the oxidant lances 230, 240, 330, 340, 211, 212, 221, 222, 311, 312, 321, 322 so that the oxygen concentration in the furnace is kept essentially constant. The control can for example take place by continuous control of the supply of oxidant through one or several oxidant lances or by operating one or several oxidant lances in a pulsating manner, with suitable relations between switched on time and switched off time. This results on the one hand in that the amount of CO in the flue gases can be controlled to desired low levels, on the other hand in that any afterburning in the space 205, 305 can be optimized.

Above, preferred embodiments have been described. However, it is obvious to the skilled person that many modifications can be made to the described embodiments without departing from the idea of the invention.

For example, an oxyfuel combustion according to the present invention can be used as a complement to one or several existing air burners in a pit furnace, to increase the maximum capacity for the pit furnace or to decrease the power of the air burner with maintained capacity but smaller negative environmental impact.

Moreover, the lances for oxidant and fuel illustrated in FIGS. 4-10 and described above can be arranged in other constellations. More oxidant lances can for instance be arranged so as to heat especially difficult to get at spaces and/or to create additional turbulence inside the furnace, depending on the actual operating conditions. The lances opening out into the V-shaped space do not need to be centrally arranged in said space, but can for example be arranged with their respective orifices somewhat displaced in the horizontal plane. In this case, it is preferred that the resulting downwards inclined oxidant stream cuts through an area to which fuel is supplied in the V-shaped space. Also, more fuel lances may be used in each aggregate or group, alternatively in other places in the furnace so that fuel is supplied to a location being cut through by one or several high velocity streams of oxidant.

Finally, it is possible to arrange one oxidant lance at low height in each one of the corners in the furnace, so that oxidant is supplied from both directions into the space under the ingots along both long sides of the furnace.

Therefore, the invention shall not be limited to the described embodiments, but may be varied within the scope of the enclosed claims.

1-10. (canceled)

11. A method for increasing temperature homogeneity in a pit furnace in which at least one ingot is to be heated, comprising:
leaning the at least one ingot against an inner wall of the pit furnace for providing a space having a triangular cross-section under the ingot between the ingot and said inner wall,
supplying a fuel to the furnace,
positioning at least one lance for oxidant with an oxygen content of at least 85 percent by weight in a furnace wall for an orifice of said at least one lance arranged inside the furnace, and
supplying said oxidant to said space at a velocity of at least 100 m/s.

12. The method of claim 11, further comprising reacting the oxidant supplied through the lance with the fuel in said space under the ingot, wherein the supplying the fuel to said space is through another lance.

13. The method of claim 11, wherein the supplying the oxidant comprises reacting a main portion of the oxidant with CO formed during combustion of the fuel in the furnace by using the oxidant supplied to a part of the furnace which is in other than the space under the ingot, such that the combustion of the fuel occurs in two stages in the furnace.

14. The method of claim 13, further comprising reducing an amount of the oxidant supplied to the furnace during combustion other than in the space for providing a total combustion mixture in the furnace other than said space to become substoichiometric.

15. The method of claim 11, wherein the supplying said oxidant is at least at sonic velocity.

16. The method of claim 11, wherein the supplying a fuel comprises arranging a plurality of lances for oxidant each having an oxygen content of at least 85 percentage by weight with their respective orifices in the furnace, and increasing the temperature homogeneity in the furnace during operation by supplying oxidant in an alternating manner through different ones of said plurality of lances or through constellations of said lances for oxidant.

17. The method of claim 11, wherein the at least one ingot is at least two ingots to be heated, the method further comprising:
leaning the at least two ingots against one each of a respective first and second opposite inner walls of the pit furnace for providing a respective space with a triangular cross-section under each one of the respective ingots,
positioning at least one respective lance for oxidant with an oxygen content of at least 85 percent by weight with its respective orifice arranged inside the furnace,
supplying the oxidant to the respective spaces through each one of the respective lances,
arranging the lances in opposite furnace walls, and
directing streams of oxidant from the respective lances into the furnace for providing a circulating flow in the furnace.

18. The method of claim 11, wherein the positioning of the at least one lance for oxidant is with its orifice at a height above a floor of the furnace and above a maximum height for an oxide scale bed in the furnace.

19. The method of claim 11, wherein the positioning of the at least one lance for oxidant is with its orifice at a height between 0.5 and 1.0 meters above a floor of the furnace.

20. The method of claim 11, further comprising measuring a level of the oxygen in the furnace with at least one lambda sensor, and controlling the oxygen supplied through the at least one lance for maintaining a constant concentration of the oxygen in the furnace.

21. The method of claim 11, wherein the positioning of the at least one lance for oxidant comprises positioning the orifice open in the space under the at least one ingot.
